(19) United States
(12) Patent Application Publication
(10) Pub. No.: US 2025/0076810 A1
(43) Pub. Date: Mar. 6, 2025

(54) APPARATUS AND METHOD FOR EXTRACTING ABERRATION OF HOLOGRAPHIC OPTICAL SYSTEM BASED ON IMAGE OPTIMIZATION

(71) Applicant: ELECTRONICS AND TELECOMMUNICATIONS RESEARCH INSTITUTE, Daejeon (KR)

(72) Inventor: Jin-Su LEE, Sejong-si (KR)

(73) Assignee: ELECTRONICS AND TELECOMMUNICATIONS RESEARCH INSTITUTE, Daejeon (KR)

(21) Appl. No.: 18/823,184

(22) Filed: Sep. 3, 2024

(30) Foreign Application Priority Data
Sep. 5, 2023 (KR) 10-2023-0117558
Aug. 14, 2024 (KR) 10-2024-0109056

(51) Int. Cl. G03H 1/08; G02B 27/00; G03H 1/22

(52) U.S. Cl. CPC G03H 1/0866; G02B 27/0025; G03H 1/0808; G03H 1/2202

(57) ABSTRACT

Disclosed herein is a method and apparatus for extracting aberration of a holographic optical system based on image optimization. The method may include generating a first Computer-Generated Hologram (CGH) dataset in which multiple images are optimized and extracting an aberration correction map of the holographic optical system using the first CGH dataset.

### CROSS REFERENCE TO RELATED APPLICATIONS

This application claims the benefit of Korean Patent Applications No. 10-2023-0117558, filed Sep. 5, 2023, and No. 10-2024-0109056, filed Aug. 14, 2024, which are hereby incorporated by reference in their entireties into this application.

### BACKGROUND OF THE INVENTION

### 1. Technical Field

The disclosed embodiment relates to hologram technology.

### 2. Description of the Related Art

Hologram technology is technology that obtains three-dimensional information of an object by recording and reconstructing the amplitude and phase information of light reflected from the object. Particularly, digital holograms enable high-resolution 3D representations through a computer simulation of a complex recording and reconstruction process of conventional holography based on optical systems, and may be used in various fields such as medicine, education, entertainment, and the like.

However, a hologram generated through a computer simulation should be input to an actual holographic optical system, and there is a problem in which the image quality of a reconstructed hologram is considerably degraded due to a phase difference caused by an error between the hologram generated assuming an ideal optical system and the actual optical system.

Generally, all optical systems contain various types of errors such as alignment errors, chromatic aberration, optical aberration, and the like, but the process of minimizing errors is performed when the optical system is designed and manufactured. Aberration may be minimized by an observer through repeated manual manipulation or may be corrected by directly measuring the aberration using an interferometer, or there is a method of repeatedly correcting a Point Spread Function (PSF). A holographic optical system is technology that obtains or reconstructs stereoscopic information using light diffraction and interference, and is sensitive to and affected by errors (=aberration) occurring in the optical system.

Particularly, when a hologram is reconstructed through a holographic display optical system, a Computer-Generated Hologram (CGH), which is calculated through a computer simulation such that light can form an image at an arbitrary location, is generated and input to a Spatial Light Modulator (SLM), whereby the hologram is reconstructed.

Here, the CGH generated through a computer simulation is calculated assuming an ideal optical system. Unfortunately, it is very complicated and is not easy to precisely measure all the errors of the optical system, so it is very difficult to reflect the actual errors of the system when the CGH is calculated.

A holographic optical system includes a light source, an SLM, and an optical system, and an error occurring in each of the components is accumulated and reflected in the holographic image reconstructed through a CGH. Here, the error may be regarded as a hardware-dependent constant. Therefore, if the accumulated error value (=constant) can be accurately extracted, the holographic optical system may be brought to an ideal state.

Here, typical errors that may occur in the light source (laser) include a phase error and a beam profile error, a pixel-wise phase error may occur in the SLM, and optical aberration may occur in the optical system. Also, all of the errors show different patterns depending on the wavelength of the input light source.

As described above, although there are various methods for measuring errors (=aberration) of a holographic optical system, a method in which a user manually corrects errors while observing a reconstructed holographic image is generally used, because the configuration of the optical system is very complex and it is difficult to precisely measure the aberration and to apply a PSF correction method to the outskirts where the aberration is very large. Recently, a method of correcting the system through hardware feedback, that is, a method called ‘Camera-in-the-loop’, has been reported. This is a method of correcting aberration by directly reflecting the error between an original image and a result captured by a camera located on the measurement surface to a CGH.

### SUMMARY OF THE INVENTION

An object of the disclosed embodiment is to extract all aberrations of the entire field occurring by passing a computer-generated hologram through a holographic display optical system.

Another object of the disclosed embodiment is to make it possible to apply the embodiment to all types of imaging optical systems as well as a holographic optical system in the same manner.

A method for extracting aberration of a holographic optical system based on image optimization according to an embodiment may include generating a first Computer-Generated Hologram (CGH) dataset by optimizing each of multiple images having different spatial frequency distributions; and extracting an aberration correction map of the holographic optical system using the first CGH dataset.

Here, generating the first CGH dataset may comprise generating the first CGH dataset by optimizing CGHs generated from the respective images, which have different spatial frequency distributions and are included in an image dataset, through Stochastic Gradient Descent (SGD).

Here, generating the first CGH dataset may comprise minimizing a first loss between images included in the image dataset and images reconstructed from the first CGH dataset corresponding to the respective images included in the image dataset.

Here, extracting the aberration correction map may include extracting a local aberration correction map dataset using the first CGH dataset and calculating a global aberration correction map based on the extracted local aberration correction map dataset.

Here, extracting the local aberration correction map dataset may include inputting a first CGH included in the first CGH dataset to an actual optical system and generating a second CGH in which optical aberration is corrected, calculating second loss between a numerical reconstructed image of the first CGH and an optical reconstructed image of the second CGH, optimizing the second CGH through Stochastic Gradient Descent (SGD) based on the second loss, and extracting a local aberration correction map based on the first CGH and the second CGH, and generating the local aberration correction map dataset may comprise repeatedly performing generating the second CGH, calculating the second loss, optimizing the second CGH, and extracting the local aberration correction map for each of the first CGHs included in the first CGH dataset, thereby generating the local aberration correction map dataset.

Here, calculating the global aberration correction map may comprise calculating the global aberration correction map by averaging multiple local aberration correction maps.

Here, calculating the global aberration correction map may comprise calculating the global aberration correction map by applying a scale factor to multiple local aberration correction maps.

Here, calculating the global aberration correction map may comprise calculating the global aberration correction map by applying a weighted scale factors to multiple local aberration correction maps.

An apparatus for extracting aberration of a holographic optical system based on image optimization according to an embodiment includes memory in which at least one program is recorded and a processor for executing the program. The program may perform generating a first Computer-Generated Hologram (CGH) dataset by optimizing each of images included in an image dataset and extracting an aberration correction map of a holographic optical system using the first CGH dataset.

Here, when generating the first CGH dataset, the program may generate the first CGH dataset by optimizing CGHs generated from the respective images included in the image dataset through Stochastic Gradient Descent (SGD).

Here, when generating the first CGH dataset, the program may minimize a first loss between images included in the image dataset and images reconstructed from the first CGH dataset corresponding to the respective images included in the image dataset.

Here, when extracting the aberration correction map, the program may perform extracting a local aberration correction map dataset using the first CGH dataset and calculating a global aberration correction map based on the extracted local aberration correction map dataset.

Here, when extracting the local aberration correction map dataset, the program may perform inputting a first CGH included in the first CGH dataset to an actual optical system and generating a second CGH in which optical aberration is corrected, calculating a second loss between a numerical reconstructed image of the first CGH and an optical reconstructed image of the second CGH, optimizing the second CGH through Stochastic Gradient Descent (SGD) based on the second loss, and extracting a local aberration correction map based on the first CGH and the second CGH, and the program may generate the local aberration correction map dataset by repeatedly performing generating the second CGH, calculating the second loss, optimizing the second CGH, and extracting the local aberration correction map for each of the first CGHs included in the first CGH dataset.

Here, when calculating the global aberration correction map, the program may calculate the global aberration correction map by averaging multiple local aberration correction maps.

Here, when calculating the global aberration correction map, the program may calculate the global aberration correction map by applying a scale factor to multiple local aberration correction maps.

Here, when calculating the global aberration correction map, the program may calculate the global aberration correction map by applying a weighted scale factors to multiple local aberration correction maps.

A method for compensating for aberration of a holographic optical system according to an embodiment includes transforming an image into a Computer-Generated Hologram (CGH), passing the CGH through a holographic display system, and generating an image by applying a previously detected aberration correction map to an image output from the holographic display system. The aberration correction map may be a global aberration correction map of the holographic optical system extracted using a first CGH dataset in which respective images included in an image set are optimized.

Here, the global aberration correction map may be an average of local aberration correction maps.

Here, the global aberration correction map may be calculated by applying a scale factor to multiple local aberration correction maps.

Here, the global aberration correction map may be calculated by applying a weighted scale factors to multiple local aberration correction maps.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a configuration diagram of a general image-optimization-based holographic optical system;

FIG. 2 is a schematic block diagram of an apparatus for compensating for aberration of a holographic optical system according to an embodiment;

FIG. 3 is a flowchart for explaining a method for extracting aberration of a holographic optical system based on image optimization according to an embodiment;

FIG. 4 is a flowchart for explaining in detail a step of generating a first CGH dataset according to an embodiment;

FIG. 5 is a flowchart for explaining in detail a step of extracting an aberration correction map according to an embodiment;

FIG. 6 is an exemplary view of the actual aberration of a holographic optical system;

FIG. 7 is an exemplary view of a result of an aberration correction map extracted from a holographic optical system according to an embodiment;

FIG. 8 is an exemplary view of a holographic image reconstructed through a first CGH according to an embodiment;

FIG. 9 is an exemplary view of a holographic image reconstructed by inputting a first CGH to a holographic display system (first CGH×aberration) according to an embodiment;

FIG. 10 is an exemplary view of a holographic image reconstructed through a second CGH (first CGH×aberration×compensatory aberration) according to an embodiment;

FIG. 11 is an exemplary view of an original image (Ground Truth) according to an embodiment; and

FIG. 12 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

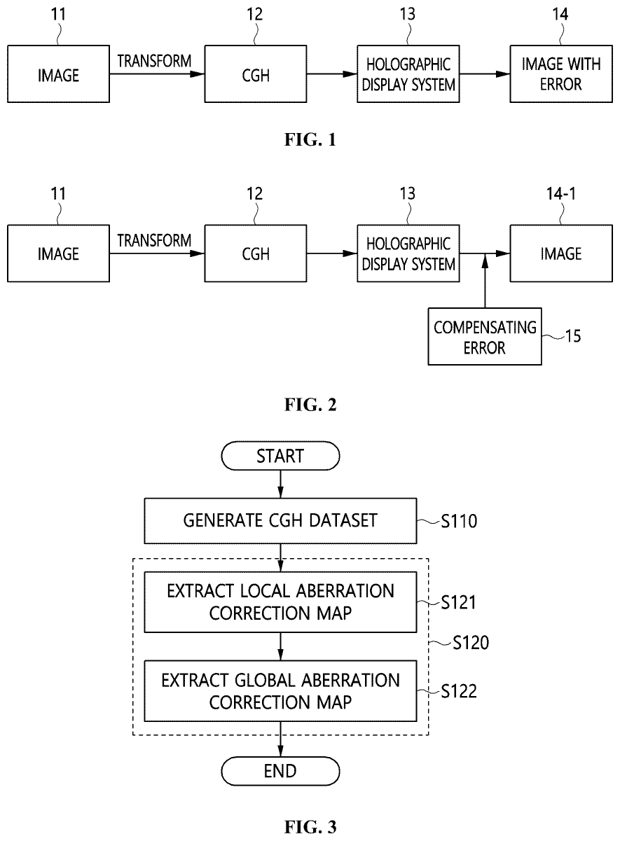

FIG. 1 is a configuration diagram of a general image-optimization-based holographic optical system.

Referring to FIG. 1, in the general image-optimization-based holographic optical system, an image 11 is transformed into a Computer-Generated Hologram (CGH) 12, and the CGH is passed through a holographic display system 13, whereby an image 14 is generated.

Here, the image quality obtained through the simulation of a currently reported CGH generation algorithm (e.g., a GS algorithm, an HGS algorithm, a DPH algorithm, a deep-learning-based algorithm, or the like) has a significant difference from the image quality obtained by inputting a CGH to the actual holographic display optical system.

A CGH generated through a computer simulation is calculated assuming an ideal optical system. Unfortunately, it is currently very difficult to reflect errors of the system at the step of calculating a CGH, because it is very complicated and not easy to precisely measure all errors in the optical system.

The holographic optical system includes a light source, an SLM, and an optical system, and errors occurring in each of the components are accumulated and reflected in a holographic image reconstructed through a CGH calculated under an ideal environment. Therefore, if the accumulated error value (=constant) can be extracted, the holographic optical system may be brought to an ideal state.

Typical errors that may occur in the light source include a phase error and a beam profile error, a pixel-wise phase error may occur in the SLM, and optical aberration may occur in the optical system. Also, all of the errors show different patterns depending on the wavelength of the input light source.

Generally, there are various methods for measuring errors of an optical system, but a method in which a user manually corrects errors while observing a reconstructed holographic image is generally used, because the configuration of a measurement optical system is very complicated and very difficult to be applied to a holographic display optical system.

However, a method proposed in the disclosed embodiment is a method of strictly separating an error (or aberration) constant value of a holographic optical system such that a CGH produces a result having the same image quality as in a simulation, and is different from an inference method based on deep learning. Also, the method proposed in the disclosed embodiment has the advantage in that it can be applied to all kinds of optical systems as well as the holographic optical system in the same manner.

FIG. 2 is a view for explaining a method for compensating for aberration of a holographic optical system according to an embodiment.

Referring to FIG. 2, the method for compensating for aberration of a holographic optical system according to an embodiment may include transforming an image 11 into a Computer-Generated Hologram (CGH) 12, passing the CGH through a holographic display system 13, and generating an image 14-1 by applying a previously detected aberration correction map 15 to the image output from the holographic display system.

Here, the aberration correction map may be the global aberration correction map of the holographic display system that is extracted using a first CGH dataset in which multiple images are optimized.

A method for extracting aberration of a holographic optical system based on image optimization for extraction of the aberration correction map will be described with reference to FIGS. 3 to 5.

FIG. 3 is a flowchart for explaining a method for extracting aberration of a holographic optical system based on image optimization according to an embodiment.

Referring to FIG. 3, the method for extracting aberration of a holographic optical system based on image optimization according to an embodiment may include generating a first CGH dataset by optimizing the respective images in an image dataset at step S110 and extracting an aberration correction map of the holographic optical system using the first CGH dataset at step S120.

According to an embodiment, a high-quality CGH dataset is required as a reference for extraction of the aberration correction map.

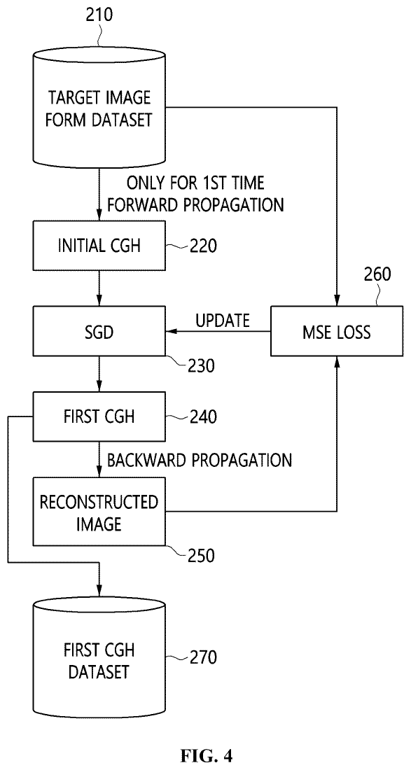

Therefore, when generating the first CGH dataset at step S110 according to an embodiment, a high-quality first CGH dataset that is optimized using Stochastic Gradient Descent (SGD) on the assumption of an ideal condition may be generated. This will be described in detail later with reference to FIG. 4.

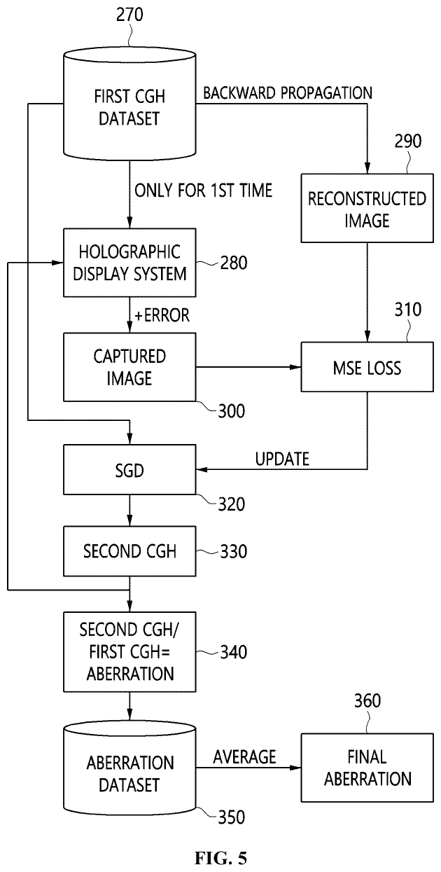

Subsequently, when extracting the aberration correction map of the holographic optical system at step S120 according to an embodiment, the aberration correction map is extracted using the high-quality first CGH dataset. That is, when the first CGH is passed through the holographic display system, the error (=aberration) is reflected, and a value for compensating for the aberration is finally extracted in the process of reconstructing the first CGH through an optimization algorithm. This will be described in detail later with reference to FIG. 5.

FIG. 4 is a view for explaining in detail a step of generating a first CGH dataset according to an embodiment.

Referring to FIG. 4, when generating the first CGH dataset at step S110 according to an embodiment, initial CGHs 220 generated from multiple images extracted from a dataset 210 are optimized through Stochastic Gradient Descent (SGD) 230, whereby the first CGH dataset 270 may be generated.

Here, generating the first CGH dataset at step S110 may comprise performing optimization 230 to minimize first loss 260 between the image included in the dataset 210 and the image 250 reconstructed from the first CGH 240 generated from the image included in the dataset 210.

Here, the optimization 230 may be repeatedly performed until a predetermined peak signal-to-noise ratio (PSNR) is satisfied. Here, the higher the target PSNR value, the more complex and time-consuming it may be to set the optimization criteria.

FIG. 5 is a flowchart for explaining in detail a step of extracting an aberration correction map according to an embodiment.

Referring to FIG. 3, extracting the aberration correction map at step S120 according to an embodiment may include extracting a local aberration correction map dataset using the first CGH dataset at step S121 and calculating a global aberration correction map based on the extracted local aberration correction map dataset at step S122.

Here, referring to FIG. 5, extracting the local aberration correction map dataset at step S121 may include generating a second CGH by reflecting optical aberration to a first CGH included in the first CGH dataset 270, calculating second loss 310 between the numerical reconstructed image 290 of the first CGH and the optical reconstructed image 300 of the second CGH, generating an optimized second CGH 330 through Stochastic Gradient Descent (SGD) 320 based on the second loss 310, and extracting a local aberration correction map 340 based on the first CGH and the second CGH.

Here, the steps from the step of generating the second CGH 330 to the step of extracting the local aberration correction map 340 are repeatedly performed for each of the first CGHs included in the first CGH dataset 270, whereby generating the local aberration correction map dataset 350 may be performed.

That is, the image quality of the image 300 captured through the camera located in the exit pupil after inputting the first CGH 270 to the actual holographic display system is compared (310) with the image quality of the reconstructed image 290 of the first CGH 270, and the SGD algorithm 320 is updated with the result thereof.

Accordingly, a CGH for correcting the optical aberration of the holographic display system in the first CGH dataset 270, that is, the second CGH 230, may be generated.

Meanwhile, the local aberration correction map is extracted from an image with an arbitrary frequency component, and because it is an aberration value optimized for the strength and distribution of the corresponding frequency component, it does not exhibit good performance for other images. In other words, the local aberration correction map depends on the spatial frequency of the original image, and it may not be applied to images other than the corresponding image.

In order to solve this problem, it is necessary to obtain a final aberration value that works on images with all kinds of spatial frequency distributions from the local aberration correction map dataset extracted from all of the images of the first CGH dataset.

Therefore, in an embodiment, calculating the global aberration correction map based on the extracted local aberration correction map dataset is performed at step S122.

Here, according to an embodiment, calculating the global aberration correction map at step S122 may comprise calculating the global aberration correction map by averaging multiple local aberration correction maps. That is, the global aberration correction map that equally works across all spatial frequencies may be extracted by simply averaging the local aberration correction maps.

Here, according to another embodiment, calculating the global aberration correction map at step S122 may comprise calculating the global aberration correction map by applying a scale factor to the multiple local aberration correction maps.

Using the global aberration correction map calculated by applying the scale factor, the final CGH may be calculated as shown in Equation (1) below:

$${Φ}_{final} = Scale factor \times ( \frac{{\sum }_{0}^{n} {φ}_{local aberration {map}_{n}}}{n} ) + {Φ}_{{1}^{st} CGH} \qquad ( 1 )$$

In Equation (1), Φ_{final} is the final CGH, and φ_{local aberration map}_{ₙ} may be a local aberration correction map. Scale factor is multiplied by the average of the local aberration correction map dataset, thereby improving the performance of the calculated global aberration correction map. Φ₁_{^{st}}_{CGH} may be obtained by optimizing the initial CGH Pinitial, and may be calculated as shown in Equation (2) below:

$${ϕ}_{{1}^{st} CGH} = SGD ( {ϕ}_{initial} ) \qquad ( 2 )$$

Meanwhile, according to a further embodiment, calculating the global aberration correction map at step S122 may comprise calculating the global aberration correction map by applying a weighted scale factors to the multiple local aberration correction maps.

Using the global aberration correction map calculated by applying the weighted scale factors, the final CGH may be calculated as shown in Equation (3) below:

$${Φ}_{final} = ( \frac{{\sum }_{0}^{n} Scale {factor}_{n} \times {φ}_{local aberration {map}_{n}}}{n} ) + {Φ}_{{1}^{st} CGH} \qquad ( 3 )$$

Here, each weight for the local correction map is individually optimized through SGD optimization, and the loss function may be designed to improve the mean PSNR and reduce the standard deviation.

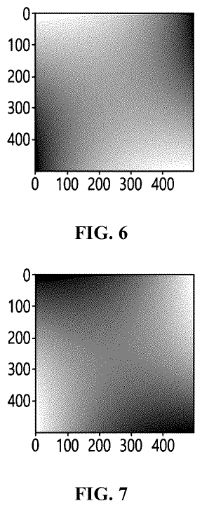

FIG. 6 is an exemplary view of the result of extracting the actual aberration of a holographic optical system, and FIG. 7 is an exemplary view of an aberration correction map result extracted from the holographic optical system according to an embodiment.

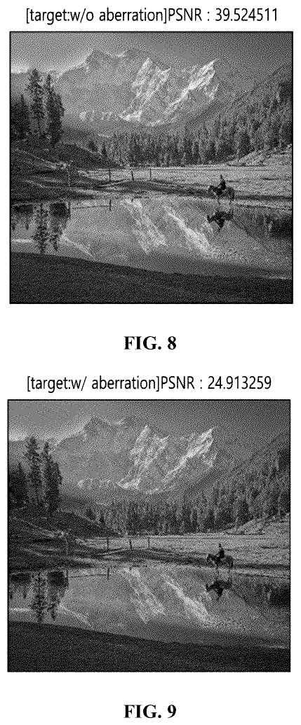

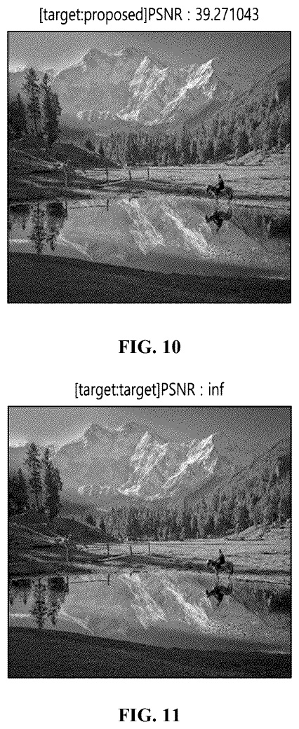

FIG. 8 is an exemplary view of a holographic image reconstructed through a first CGH according to an embodiment, FIG. 9 is an exemplary view of a holographic image reconstructed by inputting the first CGH to a holographic display system (first CGH×aberration) according to an embodiment, FIG. 10 is an exemplary view of a holographic image reconstructed through a second CGH (first CGH×aberration×compensatory aberration) according to an embodiment, and FIG. 11 is an exemplary view of an original image (Ground Truth) according to an embodiment.

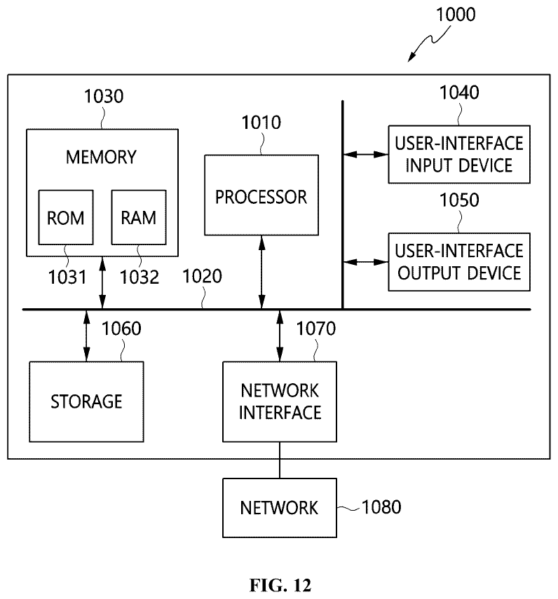

FIG. 12 is a view illustrating a computer system configuration according to an embodiment.

The apparatus for extracting aberration of a holographic optical system based on image optimization according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, all aberrations of the entire field occurring by passing a computer-generated hologram through a holographic display optical system may be extracted.

The disclosed embodiment may be applied to all types of imaging optical systems as well as a holographic optical system in the same manner.

Although the embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A method for extracting aberration of a holographic optical system based on image optimization, comprising:
generating a first Computer-Generated Hologram (CGH) dataset by optimizing each of images included in an image dataset; and
extracting an aberration correction map of the holographic optical system using the first CGH dataset.

2. The method of claim 1, wherein generating the first CGH dataset comprises generating the first CGH dataset by optimizing CGHs generated from the respective images included in the image dataset through Stochastic Gradient Descent (SGD).

3. The method of claim 2, wherein generating the first CGH dataset comprises minimizing a first loss between images included in the image dataset and images reconstructed from the first CGH dataset corresponding to the respective images included in the image dataset.

4. The method of claim 1, wherein extracting the aberration correction map includes
extracting a local aberration correction map dataset using the first CGH dataset; and
calculating a global aberration correction map based on the extracted local aberration correction map dataset.

5. The method of claim 4, wherein:
extracting the local aberration correction map dataset includes
inputting a first CGH included in the first CGH dataset to an actual optical system and generating a second CGH in which optical aberration is corrected;
calculating a second loss between a numerical reconstructed image of the first CGH and an optical reconstructed image of the second CGH;
optimizing the second CGH through Stochastic Gradient Descent (SGD) based on the second loss; and
extracting a local aberration correction map based on the first CGH and the second CGH, and
generating the local aberration correction map dataset comprises generating the local aberration correction map dataset by repeatedly performing generating the second CGH, calculating the second loss, optimizing the second CGH, and extracting the local aberration correction map for each of the first CGHs included in the first CGH dataset.

6. The method of claim 4, wherein calculating the global aberration correction map comprises calculating the global aberration correction map by averaging multiple local aberration correction maps.

7. The method of claim 4, wherein calculating the global aberration correction map comprises calculating the global aberration correction map by applying a scale factor to multiple local aberration correction maps.

8. The method of claim 4, wherein calculating the global aberration correction map comprises calculating the global aberration correction map by applying a weighted scale factors to multiple local aberration correction maps.

9. An apparatus for extracting aberration of a holographic optical system based on image optimization, comprising:
memory in which at least one program is recorded; and
a processor for executing the program,
wherein the program performs
generating a first Computer-Generated Hologram (CGH) dataset by optimizing each of images included in an image dataset, and
extracting an aberration correction map of the holographic optical system using the first CGH dataset.

10. The apparatus of claim 9, wherein, when generating the first CGH dataset, the program generates the first CGH dataset by optimizing CGHs generated from the respective images included in the image dataset through Stochastic Gradient Descent (SGD).

11. The apparatus of claim 10, wherein, when generating the first CGH dataset, the program minimizes a first loss between images included in the image dataset and images reconstructed from the first CGH dataset corresponding to the respective images included in the image dataset.

12. The apparatus of claim 9, wherein, when extracting the aberration correction map, the program performs
extracting a local aberration correction map dataset using the first CGH dataset; and
calculating a global aberration correction map based on the extracted local aberration correction map dataset.

13. The apparatus of claim 12, wherein, when extracting the local aberration correction map dataset,
the program performs
inputting a first CGH included in the first CGH dataset to an actual optical system and generating a second CGH in which optical aberration is corrected;
calculating a second loss between a numerical reconstructed image of the first CGH and an optical reconstructed image of the second CGH;
optimizing the second CGH through Stochastic Gradient Descent (SGD) based on the second loss; and
extracting a local aberration correction map based on the first CGH and the second CGH, and
the program generates the local aberration correction map dataset by repeatedly performing generating the second CGH, calculating the second loss, optimizing the second CGH, and extracting the local aberration correction map for each of the first CGHs included in the first CGH dataset.

14. The apparatus of claim 12, wherein, when calculating the global aberration correction map, the program calculates the global aberration correction map by averaging multiple local aberration correction maps.

15. The apparatus of claim 12, wherein, when calculating the global aberration correction map, the program calculates the global aberration correction map by applying a scale factor to multiple local aberration correction maps.

16. The apparatus of claim 12, wherein, when calculating the global aberration correction map, the program calculates the global aberration correction map by applying a weighted scale factors to multiple local aberration correction maps.

17. A method for compensating for aberration of a holographic optical system, comprising:
transforming an image into a Computer-Generated Hologram (CGH);
passing the CGH through a holographic display system; and
generating an image by applying a previously detected aberration correction map to an image output from the holographic display system,
wherein the aberration correction map is a global aberration correction map of the holographic optical system extracted using a first CGH dataset in which respective images included in an image set are optimized.

18. The method of claim 17, wherein the global aberration correction map is an average of local aberration correction maps.

19. The method of claim 17, wherein the global aberration correction map is calculated by applying a scale factor to multiple local aberration correction maps.

20. The method of claim 17, wherein the global aberration correction map is calculated by applying a weighted scale factors to multiple local aberration correction maps.
